(19) United States
(12) Patent Application Publication
(10) Pub. No.: US 2025/0140075 A1
(43) Pub. Date: May 1, 2025

(54) ADAPTIVE REAL-TIME SPORTS EVENT SIMULATION AND OPTIMIZATION SYSTEM

(71) Applicant: BetFully, Inc., Carlsbad, CA (US)

(72) Inventors: Erik Groset, Carlsbad, CA (US); Peter Groset, Waterford, WI (US); Georgio Feghali, La Jolla, CA (US); Max Norman, Del Mar, CA (US); Jake Kosakoff, Del Mar, CA (US); Stephen Deslate, San Diego, CA (US); Elioth Almada Sanabia, Chula Vista, CA (US); Christopher Ramos, San Diego, CA (US)

(21) Appl. No.: 18/933,991

(22) Filed: Oct. 31, 2024

Related U.S. Application Data
(60) Provisional application No. 63/595,283, filed on Nov. 1, 2023.

(51) Int. Cl. G07F 17/32

(52) U.S. Cl. CPC G07F 17/3288

(57) ABSTRACT

Multi-faceted machine learning model systems and methods are disclosed that integrate historical data, user-specific criteria, and prioritized real-time event updates. The machine learning model systems and methods may be selected and weighed to optimize simulation accuracy based on event type, player status, and user-defined constraints, such as risk tolerance and preference for specific teams, sports or players. The machine learning model is applied to a first historical outcome and a second historical outcome to generate a predictive outcome responsive to a user query, the user query having a first keyword vector and a second keyword vector. The machine learning model is applied to a real-time event and the predictive outcome to generate an updated predictive outcome. A prediction error indicative of a difference between the predictive outcome and the updated predictive outcome can be determined.

### CROSS-REFERENCE TO RELATED APPLICATIONS

This application claims priority to and the benefit of the earlier filing date of U.S. Provisional Patent Application Ser. No. 63/595,283, filed Nov. 1, 2023, the contents of which are fully incorporated by reference herein in its entirety.

### TECHNICAL FIELD

The subject matter described herein relates to adaptive real-time sports event simulation and optimization systems.

### BACKGROUND

Machine learning models, such as large language models, are advanced learning models that are capable of processing natural language tasks. These models can be used in various predictive models due to their ability to process vast amounts of historical data and generate complex predictive analytics. These models can find patterns or make decisions from unseen datasets, such as latent information. However, machine learning models have struggled to provide precise and actionable predictions in real-time environments. These limitations can result in predictions that are overly generalized and lack specificity and accuracy. Moreover, in the context of sports betting and sports wagering, machine learning models can struggle to provide real-time insights and insightful betting predictions.

### SUMMARY

The disclosure relates to real-time predictive analytics and optimization systems designed for dynamic sports betting environments. The simulation and optimization system leverages machine learning to integrate historical data, real-time event data, and a range of user-specific criteria-including sport, event type, team, player, betting time frame, bet type, market liquidity, preferred odds, historical performance, and individual bet sizing preferences. This allows for adaptive, personalized betting recommendations that account for user-defined risk, bankroll, and situational factors, providing continuously optimized predictions.

In an aspect, a machine learning model can be applied to a first historical outcome and a second historical outcome to generate a predictive outcome responsive to a user query. The first historical outcome and the second historical outcome can be selected based on a first keyword vector and a second keywork vector obtained by parsing the user query. Further, the machine learning model can be applied to a real-time event and the predictive outcome to generate an updated predictive outcome. The real-time event can be obtained by parsing the real-time event from a real-time event feed based on the first keyword vector and the second keyword vector. A prediction error can be determined which is indicative of a difference between the predictive outcome and the updated predictive outcome.

One or more of the following features can be included in any feasible combination. For example, the first historical outcome and the second historical outcome can be obtained by searching a historical database using the first keyword vector and the second keyword vector with the historical database communicatively coupled to the machine learning model. The updated predictive outcome can be provided in response to the prediction error satisfying a prediction error threshold.

In response to determining the real-time event, a first application programming interface call can be initiated to a first external database to obtain a first statistic indicative of how the real-time event affects the predictive outcome. The machine learning model can be applied to the first statistic and the predictive outcome to generate the updated predictive outcome. In response to determining the real-time event, a second application programming interface call can be initiated to a second external database to obtain a second statistic indicative of how the real-time event affects the predictive outcome. The machine learning model can be applied to the second statistic and the predictive outcome to generate the updated predictive outcome.

The first application programming interface call can be initiated prior to the second application programming interface call. The machine learning model can be applied to the second statistic while waiting to obtain the first statistic if the second statistic is obtained from the second external database prior to obtaining the first statistic from the first external database. A user interface can be generated that provides an intermediate predictive outcome while waiting to obtain the first statistic from the first external database. The intermediate predictive outcome can be generated in response to generating the updated predictive outcome based on applying the machine learning model to the second statistic and the predictive outcome.

Real-time events can be continuously determined by monitoring the real-time event feed using the first keyword vector and the second keyword vector. The machine learning model can be continuously applied to the additional real-time events and the predictive outcome to generate the updated predictive outcome. The continuously determining the additional real-time events and the continuously applying the machine learning model can occur concurrently using parallel processing.

The machine learning model can be capable of generating Monte Carlo simulations that are refined using linear programming that include assigning probabilities to the Monte Carol simulations.

Non-transitory computer program products (i.e., physically embodied computer program products) are also described that store instructions, which when executed by one or more data processors of one or more computing systems, causes at least one data processor to perform operations herein. Similarly, computer systems are also described that can include one or more data processors and memory coupled to the one or more data processors. The memory can temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram illustrating an example process of applying a machine learning model to generate a predictive outcome and an updated predictive outcome.

FIG. 2 is a system diagram illustrating an example system that applies a machine learning model to generate a predictive outcome and an updated predictive outcome.

FIG. 3 is a system diagram illustrating an example network of FIG. 2.

FIG. 4 is a system diagram illustrating an example recalibration engine of FIGS. 2 and 3.

FIG. 5 is a system diagram of one or more devices and/or one or more systems of FIGS. 2, 3, and 4.

FIG. 6 is a data flow diagram illustrating an example data communication flow for applying a machine learning model to generate a predictive outcome and an updated predictive outcome.

Like reference symbols in the various drawings indicate like elements.

### DETAILED DESCRIPTION

Large language models (LLMs) are computational models designed for natural language processing tasks. Traditionally, LLMs can be used in various predictive models due to their ability to process vast amounts of historical data, develop statistical relationships from this data, and generate predictive insights. While this approach can work in simpler tasks that rely on large historical datasets, these models can be limited by their static and historical nature. Specifically, without real-time information, these models can be unable to provide updated suggestions or recalibrated predictions as new information emerges. For example, in the context of sports betting, predictive models typically rely on historical data to generate predictions, such as past game results, team performance, and player statistics. However, without real-time information, these models cannot account for live factors such as unexpected player injuries, weather conditions, or in-game adjustments. Consequently, traditional models are left with a static view of the game, missing on dynamic real-time insights that could substantially improve accuracy and offer new insights.

Accordingly, some implementations of the current subject matter include an approach to generating predictive outcomes based on historical data and real-time events. By applying a machine learning model to the historical data and real-time events, the prediction outcomes can provide recalibrated predictions based on real-time information. Further, in some implementations, the machine learning model can be dynamically updated to provide accurate and responsive predictions based on the latest, most relevant data. Some implementations also include application programming interface (API) calls to an external database to obtain statistics indicative of how the real-time events affects the predictive outcome.

In addition, some implementations of the subject matter can include parallelizing the machine learning model analysis, enabling faster data processing and providing timely recommendations with minimal delay. Furthermore, some implementations can reduce the latency required to process the real-time events, enabling access to larger and computationally complex datasets.

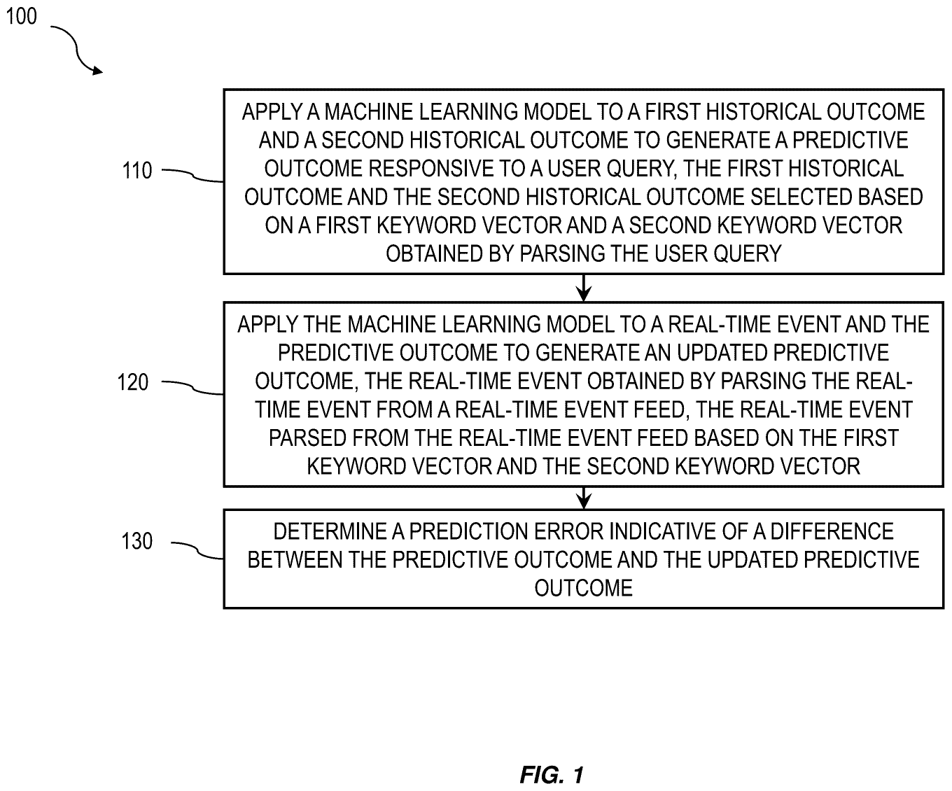

FIG. 1 is a process flow diagram illustrating an example method 100 of applying a machine learning model to generate a predictive outcome and an updated predictive outcome.

At 110, a machine learning model can be applied to a first historical outcome and a second historical outcome to generate a predictive outcome responsive to a user query. The machine learning model can be used to determine insights and predictions by analyzing the historical outcomes. The machine learning model can include a linear regression model, a neural network, a decision tree model, or other large language models.

The machine learning model can be applied to a first historical outcome and a second historical outcome. The historical outcomes can include historical data, such as statistics, past events, and previous analytics. In the context of sports betting, the historical outcomes can include information such as a team's statistics, player-specific statistics, historical trends, or analytics describing how teams typically perform. Team statistics can include information such as the team's performance over previous seasons, team-specific statistics such as home and away performance, win-loss records, and previous matchups. The historical outcomes can also include previous analytics, such as previously generated predictions or outcomes.

The machine learning model can be applied to a first historical outcome and a second historical outcome to generate a predictive outcome responsive to a user query. For example, the machine learning model can analyze the historical outcomes and make an informed prediction based on the user query. In some implementations, the machine learning model can use supervised learning to train the model on known inputs, such as the historical outcomes, to predict future outcomes and predictions in the predictive outcome. In some implementations, the machine learning model can find hidden patterns or latent information from the historical outcomes in the generation of the predictive outcome.

The predictive outcome can provide insights and information into the outcome of future events. In some implementations, the predictive outcome can include information such as statistical probabilities, predictions, and anticipated results. For example, the predictive outcome can include information such as probability distributions for match outcomes, including win, loss, draw, and other event-specific results like player performance or specific events. Additionally, the predictive outcome can include latent information, such as baseline predictions that reflects long-term trends, team strengths, and player performance under various conditions. In some implementations, the predictive outcome can include preliminary results or data that can be used in future predictions.

The predictive outcome can be generated responsive to a user query. The user query can originate from a user device, an entity, a network domain, or from other sources. The user query can interact with the machine learning model, for example by asking a question, requesting feedback, or inquiring about a prediction. In some implementations, the user query can include a request for a game prediction, player outcome, statistical results, user-specific feedback, or other sport-related inquiries.

A first keyword vector and a second keyword vector can be obtained by parsing the user query. The keyword vectors can capture essential elements of the user query that can be understood and processed by the machine learning model. For example, the keyword vectors can be obtained by parsing the user query and extracting relevant words, phrases, or data. In some implementations, the keyword vectors can assign weights to terms based on the relevance or frequency within the user query. The keyword vectors can also be determined by contextual information related to the machine learning model, the user query, or from previous requests. The first historical outcome and the second historical outcome can be selected based on a first keyword vector and a second keyword vector. For example, the keyword vectors can be used to search across databases or historical files to obtain relevant historical outcomes.

At 120, the machine learning model can be applied to a real-time event and the predictive outcome to generate an updated predictive outcome. In some implementations, the real-time event can include real-time data (e.g., live data or live updates) captured from an ongoing event. The real-time event can also include information related to a past event or information distilled from a compilation of events. In some implementations, the real-time event can include in-game data such as injuries, player substitutions, score changes, in-game changes, betting odds, and other real-time metrics. The real-time event can also include information associated with betting optimizations, such as betting odds across sport books and shifts in betting odds to identify optimal betting opportunities.

The machine learning model can generate an updated predictive outcome from the real-time event and the predictive outcome. The updated predictive outcome can include context-aware predictions based on the historical data and real-time data. For example, the updated predictive outcome can include information such as real-time updates, statistical changes, and new recommendations. In some implementations, the machine learning model can generate an updated predictive outcome from multiple real-time events and the predictive outcome. For example, the updated predictive outcome can provide real-time suggestions as the live event progresses and more real-time events are received. In some implementations, the updated predictive outcome can include adjustments to the predictive outcome based on the real-time events. For example, the updated predictive outcome can include information such as fluctuations, volatility, or updated recommendations to the predictive outcome based on the real-time events. For instance, by receiving information such as player injuries, scores, penalties, weather changes, or substitutions, the machine learning model can make updated predictions that are more accurate and timely.

In some implementations, the updated predictive outcome can provide further insights and predictions into the outcome of future events. For example, given a situation where, a day prior to the sporting event, a player appears to be limping or is spotted late at night, the machine learning model can factor these real-time events in its updated predictive outcome. In some implementations, the updated predictive outcome can include higher quality predictions than the predictive outcome. In some implementations, the updated predictive outcome can include predictions that would not be possible from just the predictive outcome based on historical data, such as current betting odds, optimized betting strategies, and market liquidity considerations across multiple sport books.

The machine learning model can intelligently balance information from the predictive outcome and incoming real-time events. In some implementations, the machine learning model can tailor its predictions based on situational relevance and user preferences. For example, depending on the user's preference and history of user queries, the machine learning model can tailor the updated predictive outcome to align with the user-specific inquires or behaviors, such as risk tolerance and betting strategies. In some implementations, the machine learning model can weigh the predictive outcome and the incoming real-time events equally in generating the updated predictive outcome. However, as more real-time data is received, the model can dynamically adjust its calculations to prioritize the real-time data over the predictive outcome based on historical data. This can allow the model to provide more accurate predictions as more real-time data is received.

The real-time event can be obtained by parsing a real-time event feed based on the first keyword vector and the second keyword vector. For example, the real-time event feed can include an API, network, sportsbook, or other services that provides real-time data. In some implementations, the real-time event can be obtained by parsing multiple real-time event feeds.

At 130, a prediction error indicative of a difference between the predictive outcome and the updated predictive outcome can be determined. In some implementations, the prediction error can reflect how much of the incoming real-time event impacts the machine learning model's original prediction. For example, if a significant real-time event occurs, such as a sudden or unexpected event, the updated predictive outcome can differ substantially from the original prediction error and impact the accuracy of the prediction. In some implementations, a larger prediction error can indicate that the prediction is more accurate due to the increase of real-time events.

In some implementations, the updated predictive outcome can be provided in response to the prediction error satisfying a prediction error threshold. For example, the prediction error threshold can indicate the minimum level of change required to justify providing the updated predictive outcome. In some implementations, the prediction error threshold can indicate a maximum allowable change before providing the updated predictive outcome. The prediction error threshold may be satisfied is the updated outcome has a 2% chance or greater of affecting the final outcome. The prediction error threshold may be determined by user criteria. For example, a user may decide a betting threshold needs to change by $5.

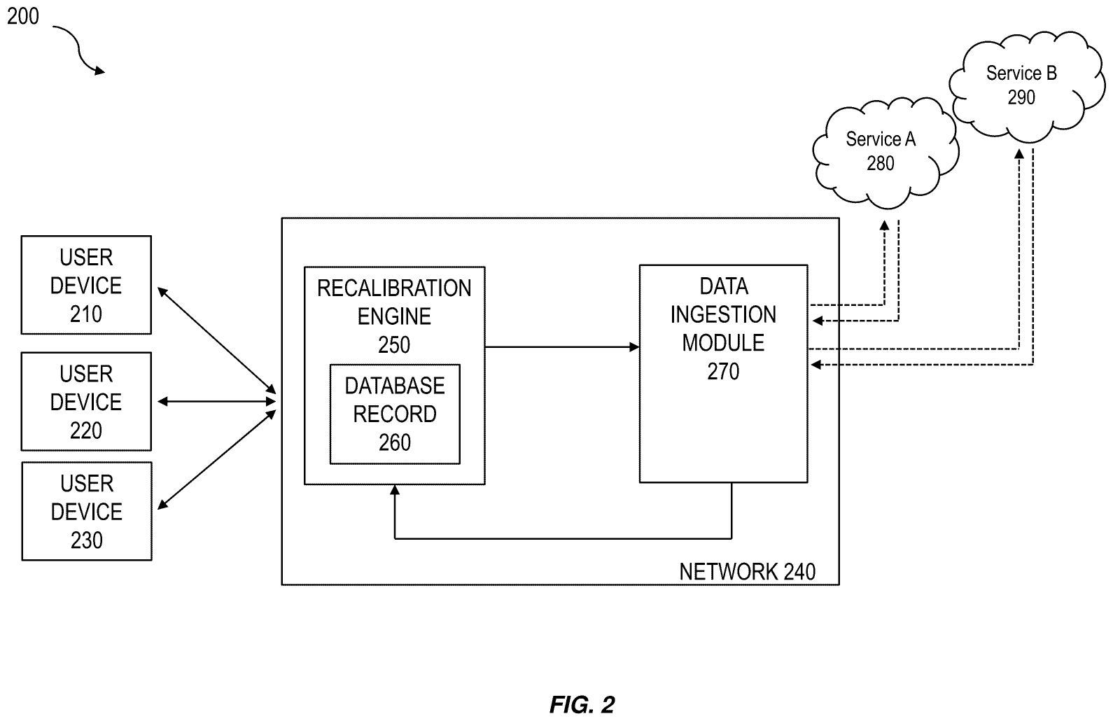

FIG. 2 is a system diagram illustrating an example system 200 that applies a machine learning model to generate a predictive outcome and an updated predictive outcome. The system 200 can include user devices (user device 210), user device 220, and user device 230), network 240, and services (service A 280 and service B 290). The network 240 can include a data ingestion module 270 and recalibration engine 250 with a database record 260.

A user device 210 can send the user query to the network 240. In some implementations, the user device 210 can send the first historical outcome, the second historical outcome, or the keyword vectors to the network 240. In some implementations, there are multiple user devices, such as user device 220, user device 230, or other user devices. The user device 210 can include a mobile phone or computing device incorporating applications or services. The user device 210 can further include a server or a network node inquiring on behalf of internal or shared services. The user device 210 can also be an automated system capable of performing recurring or event-driven inquires to network 240. The user device 210 can also include a software service or application running on a platform designed to send inquires to network 240. The user device 210 can also include other devices found in computerized or networking environments.

The network 240 can receive the user query from the user device 210. Network 240 can include a local area network (LAN), wide area network (WAN), cloud-based virtualized environment, or other networking configurations.

Service A 280 and service B 290 can include sources that hosts an API, network, sportsbook, or other source of real-time data. For example, the service can include a database or a network of live data sources that aggregates information from multiple feeds. In some implementations, service A 280 and service B 290 are contained in a singular network or database. In some implementations, service A 280 and service B 290 are contained across multiple databases or networks.

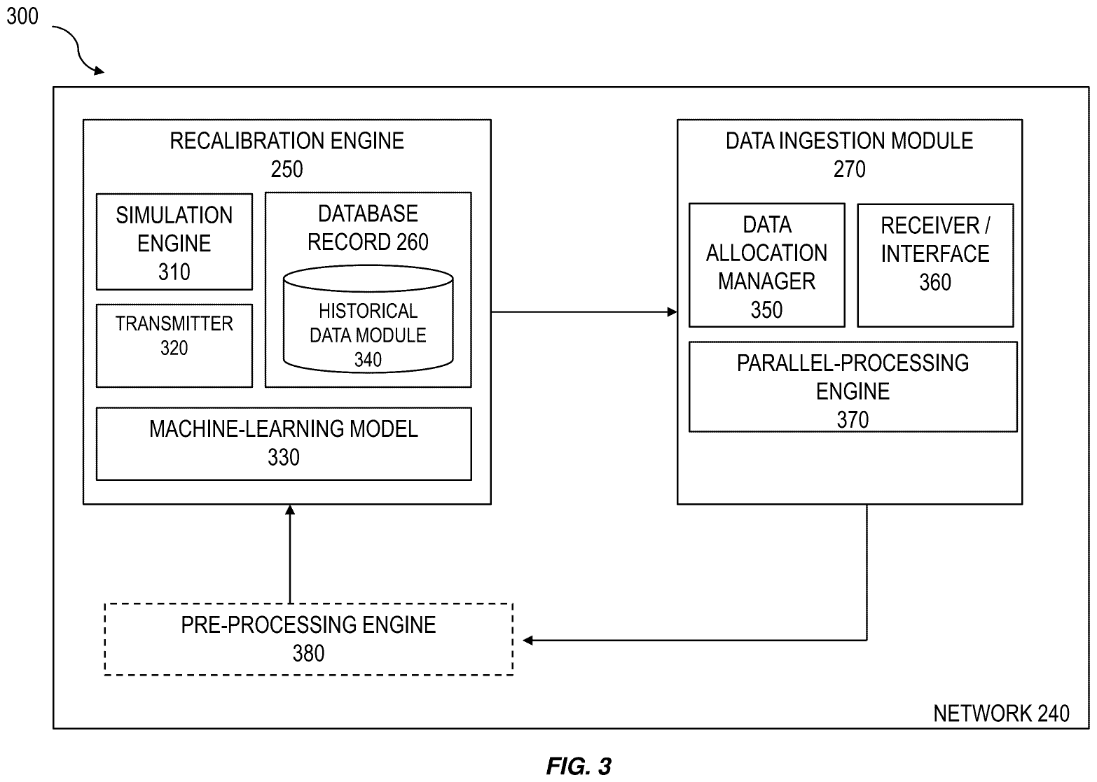

One example implementing network 240 is shown in FIG. 3. Network 240 includes a recalibration engine 250 and a data ingestion module 270. In some implementations, network 240 includes a pre-processing engine 380.

The data ingestion module 270 can receive real-time events from multiple services. In some implementations, the data ingestion module 270 can also receive the real-time event feed and parse the real-time event feed to obtain the real-time event. The data ingestion module 270 can also receive information associated with the real-time event feed and parse the information to obtain the real-time event. In some implementations, the network 240 includes a single data ingestion module 270. In some implementations, the network 240 includes multiple data ingestion modules 270. The data ingestion module 270 can include a data allocation manager 350, a receiver/interface 360, and a parallel-processing engine 370.

The data ingestion module 270 can include a receiver/interface 360 to receive real-time data from various services. The receiver can be optimized for low latency across multiple high-bandwidth or high traffic services. For example, the data ingestion module 270 can include multiple receivers to receive the real-time events from a plurality of services. In some implementations, the receiver/interface 360 can receive the real-time event feed directly from the service.

The data ingestion module 270 can also include a parallel-processing engine 370. The parallel-processing engine 370 can parse multiple real-time event feeds to determine the real-time event from the keyword vectors. For example, the parallel-processing engine can include multiple data processors. with each data processor assigned to a separate real-time event feed. In some implementations, the real-time event feeds can be divided into threads. Each data processor in the parallel-processing engine 370 can process each thread individually, allowing individual threads associated with different real-time event feeds to complete without waiting for other threads. In some implementations, the data ingestion module 270 includes multiple parallel-processing engines 370.

The data ingestion module 270 can also include a data allocation manager 350 to distribute and manage the various real-time event feeds across the parallel-processing engine 370. In some implementations, the data allocation manager 350 can be optimized for low latency to efficiently handle the continuous flow of real-time event feeds. For example, the data allocation manager 350 can quickly expand the real-time event feeds into a plurality of data processing threads and schedule the threads on the data processors. Once the data processor finishes processing the thread, the data allocation manager 350 can quickly schedule another thread on the data processor without waiting for other threads. In some implementations, the data ingestion module 270 can use machine learning techniques to predict bottlenecks in the real-time event feeds and adjust scheduling and allocation to maintain optimal latency.

The data allocation manager 350 can also structure the incoming real-time events. For example, the receiver/interface 360 can receive unstructured data from multiple services of real-time event feeds. The data allocation manager 350 can normalize the data and created a unified structured format from the different services.

Returning to FIG. 3, the network 240 can also include a pre-processing engine 380. The pre-processing engine 380 can receive the real-time event from the data ingestion module 270. In some implementations, the pre-processing engine can filter, normalize, and structure the real-time event. For example, the pre-processing engine 380 can examine the incoming real-time events and remove noisy or irrelevant real-time events. This ensures that only clean and structured data can be processed by the recalibration engine 250. In some implementations, the pre-processing engine 380 can apply statistical filtering to remove outliers and irrelevant real-time events. In some implementations, the pre-processing engine can prioritize higher-priority events. For example, the pre-processing engine can prioritize higher-priority events (e.g., goals, injuries) over other events before sending to the recalibration engine 250. In some implementations, the pre-processing engine can use machine learning techniques to identify patterns in the real-time events and filter outliers to improve the accuracy of the predictions.

In some implementations, the pre-processing engine 380 can include a priority queue and assign a higher priority to critical real-time events. For example, the pre-processing engine 380 can assign a higher priority to game events (e.g., goals, injuries) while other data (e.g., ongoing player performance) can be assigned a lower priority. This can allow the recalibration engine 250 to receive higher priority data to generate more accurate predictions.

The network 240 can also include a recalibration engine 250. The recalibration engine 250 can include a simulation engine 310, a database record 260, a transmitter 320, and a machine learning model 330.

The recalibration engine 250 can apply the machine learning model to the first historical outcome and the second historical outcome to generate a predictive outcome responsive to the user query. Further, the recalibration engine 250 can apply the machine learning model 330 to a real-time event and the predictive outcome to generate an updated predictive outcome.

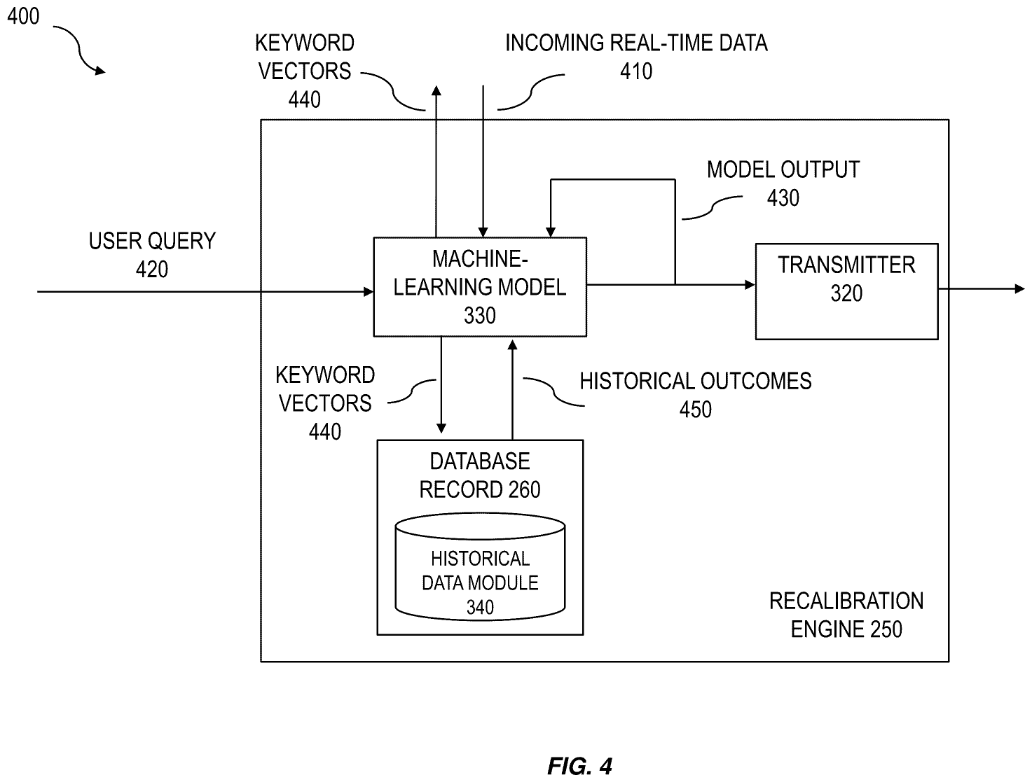

One example illustrating the data flow in the recalibration engine 250 is shown in FIG. 4. For example, the recalibration engine 250 can receive the user query 420 and obtain a first keyword vector and a second keyword vector by parsing the user query. In addition, the recalibration engine 250 can select the first historical outcome and the second historical outcome based on the first keyword vector and the second keyword vector by searching in the database record 260.

In some implementations, the first historical outcome and the second historical outcome are obtained by searching a historical database using the first keyword vector and the second keyword vector. For example, the database record 260 can include historical data module 340 that can securely store, retrieve, and manage historical data. The database record can include information such as the game results, player statistics, betting odds history, and weather conditions. The database record 260 can receive the keyword vectors 440 and determine the historical outcomes 450 (e.g., the first historical outcome and the second historical outcome) by searching the historical data module 340. For example, the historical data module 340 can return historical outcomes 450, including information associated with historical data, such as statistics, past events, and previous analytics.

The recalibration engine 250 can apply the machine learning model 330 to the first historical outcome and the second historical outcome to generate a predictive outcome responsive to the user query. In some implementations, the recalibration engine 250 can be parallelized to process multiple data streams simultaneously. For example, the machine learning model 330 can be parallelized across multiple data inputs to minimize latency and ensure the generation of the predictive outcomes in real-time. In some implementations, the recalibration engine 250 can automatically apply the machine learning model 330 upon receiving the historical outcomes. In some implementations, the recalibration engine 250 can apply the machine learning model 330 upon indication from the user query.

The machine learning model 330 can generate a model output 430, which includes the predictive outcome. The predictive outcome can be provided to the user device 210 using transmitter 320. For example, if the user device 210 sends a request that requires only historical data, the transmitter 320 can provide the predictive outcomes to the user. The predictive outcome can also be reused by the machine learning model 330 for future predictions, generation of the updated predictive outcomes, or stored in the database record 260.

The recalibration engine 250 can apply the machine learning model 330 to the real-time event and the predictive outcome to generate an updated predictive outcome. In some implementations, the recalibration engine 250 can automatically apply the machine learning model 330 upon receiving the real-time events. In some implementations, the recalibration engine 250 can apply the machine learning model 330 upon indication from the user query.

The machine learning model 330 can generate a second model output 430, which includes the updated predictive outcome. In some implementations, the transmitter 320 can provide the updated predictive outcome directly to the user device. In some implementations, the transmitter 320 can provide information associated with the updated predictive outcome or a summary of the machine learning analysis. In some implementations, the transmitter 320 can request the user device for additional information or user queries. In some implementations, the machine learning model 330 can continually refine the updated prediction outcome based on new real-time events.

In some implementations, the machine learning model 330 can generate and provide an updated predictive outcome using latent information or behavioral analysis that wasn't explicitly identified in the user query. For example, in the sports betting context, the machine learning model 330 can identify patterns of risky behaviors in the user queries or the user activity, such as irregular or frequent bets, increased risk tolerance, and signs of impulsive decision-making. If these patterns align with signs of mental health issues or gambling addictions, the updated predictive outcome can notify the user about these behaviors and recommend future steps. For example, the model could suggest betting limits or provide resources or referrals for professional help or wellness tools.

In some implementations, the machine learning model 330 can determine a prediction error indicative of a difference between the predictive outcome and the updated predictive outcome. For example, the machine learning model 330 can analyze the difference between the predictive outcome and the updated predictive outcome. Once the prediction error satisfies a prediction error threshold, the machine learning model 330 can provide the updated predictive outcome to the transmitter 320.

In some implementations, the machine learning model 330 can be capable of generating Monte Carlo simulations that are refined using linear programming that include assigning probabilities to the Monte Carlo simulations. For example, the machine learning module can update the updated prediction outcome by using Monte Carlo simulations. The Monte Carlo simulations can provide updated probability distributions for match outcomes, including win, loss, draw, and other event-specific results like player performance. The network can minimize latency by using parallel processing for the Monte Carlo simulations, allowing for real-time updated prediction outcomes. In some implementations, the Monte Carlo simulations can be used with linear programming to optimize the recommendations. For example, the machine learning model 330 can use linear programming to refine the Monte Carlo simulations to identify optimal scenarios and assign probabilities to the scenarios. The machine learning model can select a subset of scenarios that are tailored to a maximum or minimum values. For example, the machine learning model 330 can select a subset of updated prediction outcomes that maximize the expected return based on constraints such as user risk tolerance, desired odds, or time remaining in a game.

In some implementations, the machine learning model 330 can use linear programming for optimization in arbitrage opportunities. For example, the machine learning model 330 can identify arbitrage opportunities by comparing odds across sportsbooks in real-time and determine betting recommendations that guarantee profit regardless of the event's outcome. In some implementations, the machine learning model 330 can determine optimal allocations for the arbitrage by calculating the precise amount to wager on each outcome to ensure the total return is a guaranteed profit.

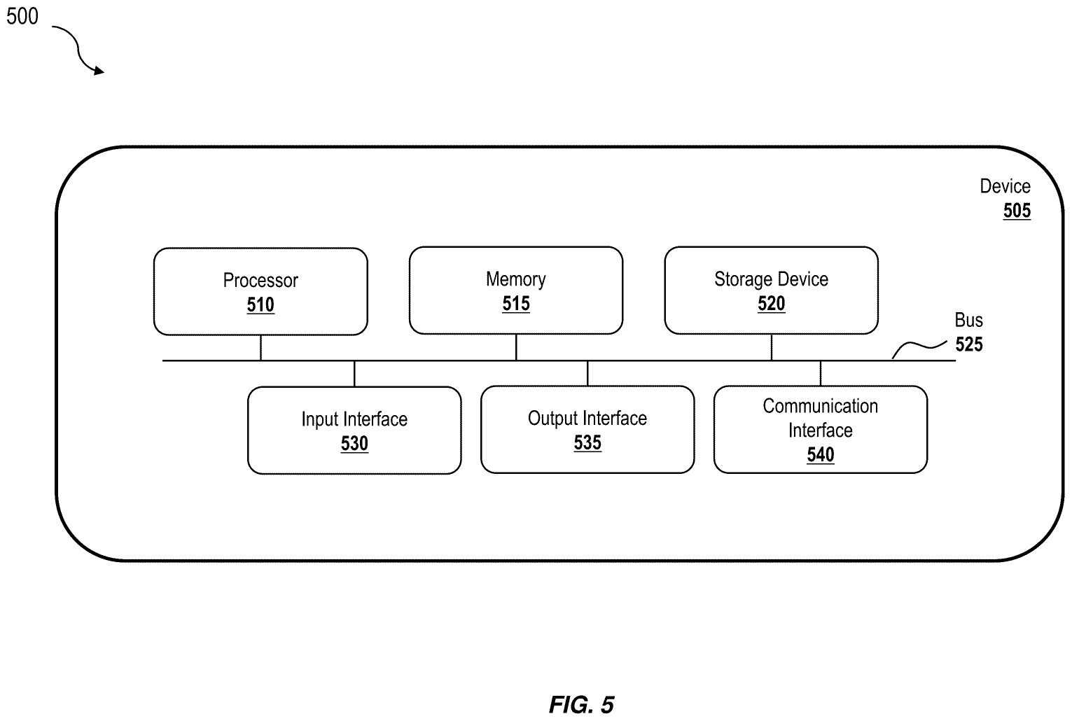

FIG. 5 is a system diagram illustrating an example system implementing network 240. As illustrated, device 505 includes processor 510, memory 515, storage component 520, input interface 530, output interface 535, communication interface 540, and bus 525.

Bus 525 includes a component that permits communication among the components of device 505. In some implementations, processor 510 can be implemented in hardware, software, or a combination of hardware and software. In some examples, processor 510 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 515 includes random access memory (RAM), read-only memory (ROM), and/or another type of dynamic and/or static storage device (e.g., flash memory, magnetic memory, optical memory, and/or the like) that stores data and/or instructions for use by processor 510.

Storage component 520 stores data and/or software related to the operation and use of device 505. In some examples, storage component 520 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 530 includes a component that permits device 505 to receive information, such as via user input (e.g., a touchscreen display, a keyboard, a keypad, a mouse, a button, a switch, a microphone, a camera, and/or the like). Additionally or alternatively, in some implementations input interface 530 includes a sensor that senses information (e.g., a global positioning system (GPS) receiver, an accelerometer, a gyroscope, an actuator, and/or the like). Output interface 535 includes a component that provides output information from device 505 (e.g., a display, a speaker, one or more light-emitting diodes (LEDs), and/or the like).

In some implementations, communication interface 540 includes a transceiver-like component (e.g., a transceiver, a separate receiver and transmitter, and/or the like) that permits device 505 to communicate with other devices via a wired connection, a wireless connection, or a combination of wired and wireless connections. In some examples, communication interface 540 permits device 505 to receive information from another device and/or provide information to another device. In some examples, communication interface 540 includes an Ethernet interface, an optical interface, a coaxial interface, an infrared interface, a radio frequency (RF) interface, a universal serial bus (USB) interface, a Wi-Fi® interface, a cellular network interface, and/or the like.

In some implementations, device 505 performs one or more processes described herein. Device 505 performs these processes based on processor 510 executing software instructions stored by a computer-readable medium, such as memory 515 and/or storage component 520. A computer-readable medium (e.g., a non-transitory computer readable medium) is defined herein as a non-transitory memory device. A non-transitory memory device includes memory space located inside a single physical storage device or memory space spread across multiple physical storage devices.

In some implementations, software instructions are read into memory 515 and/or storage component 520 from another computer-readable medium or from another device via communication interface 540. When executed, software instructions stored in memory 515 and/or storage component 520 cause processor 510 to perform one or more processes described herein. Additionally or alternatively, hardwired circuitry can be used in place of or in combination with software instructions to perform one or more processes described herein. Thus, embodiments described herein are not limited to any specific combination of hardware circuitry and software unless explicitly stated otherwise.

Memory 515 and/or storage component 520 includes data storage or at least one data structure (e.g., a database and/or the like). Device 505 can be capable of receiving information from, storing information in, communicating information to, or searching information stored in the data storage or the at least one data structure in memory 515 or storage component 520. In some examples, the information includes network data, input data, output data, or any combination thereof.

In some implementations, device 505 can be capable of executing software instructions that are either stored in memory 515 and/or in the memory of another device (e.g., another device that is the same as or similar to device 505). As used herein, the term “module” refers to at least one instruction stored in memory 515 and/or in the memory of another device that, when executed by processor 510 and/or by a processor of another device (e.g., another device that is the same as or similar to device 505) cause device 505 (e.g., at least one component of device 505) to perform one or more processes described herein. In some implementations, a module can be implemented in software, firmware, hardware, and/or the like.

The number and arrangement of components illustrated in FIG. 5 are provided as an example. In some implementations, device 505 can include additional components, fewer components, different components, or differently arranged components than those illustrated in FIG. 5. Additionally or alternatively, a set of components (e.g., one or more components) of device 505 can perform one or more functions described as being performed by another component or another set of components of device 505.

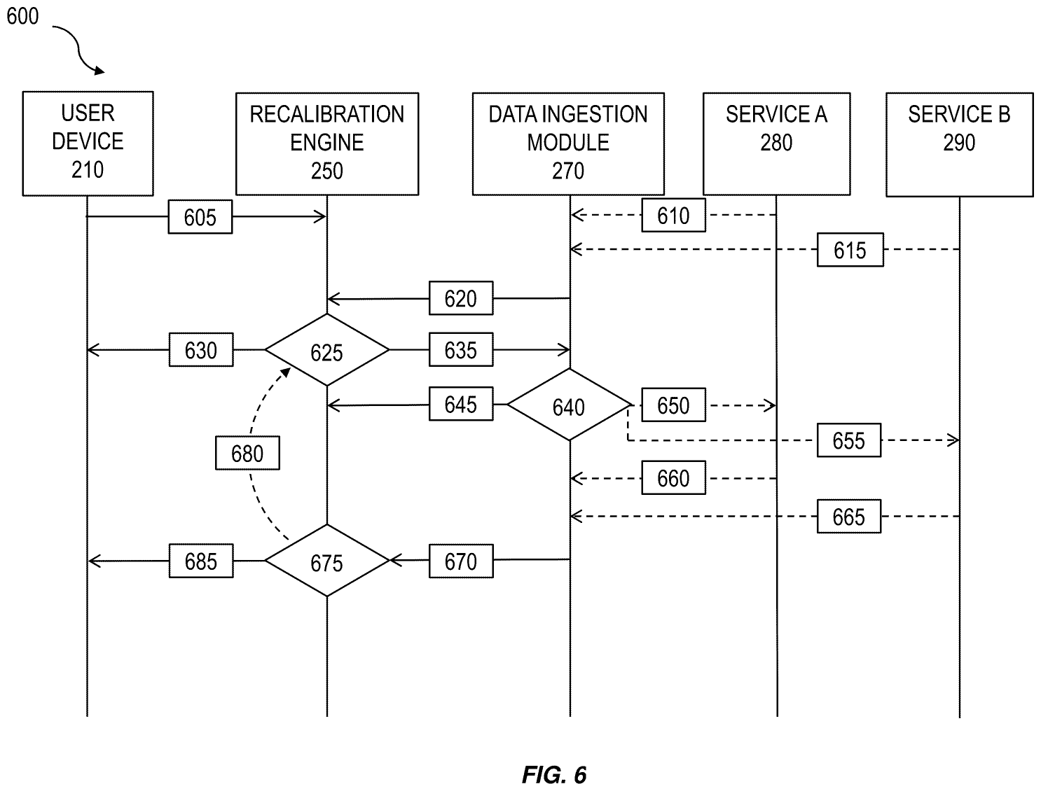

FIG. 6 is a data flow diagram illustrating an example data communication flow for applying a machine learning model 330 to generate a predictive outcome and an updated predictive outcome. At 605, the recalibration engine 250 can receive the user query from the user device 210. At 610, the data ingestion module 270 can receive a real-time event feed from service A 280. At 615, the data ingestion module 270 can receive a real-time event feed from service B 290. Once the data ingestion module 270 obtains the real-time event by parsing the real-time event feed using the keyword vectors, the real-time event can be sent to the recalibration engine 250 at 620.

At 625, the recalibration engine 250 can generate the predictive outcome by applying a machine learning model 330 to a first historical outcome and a second historical outcome and generate the updated predicted outcome based on the predicted outcome and the real-time event. At 630, the predicted outcome or the updated predicted outcome can be provided to the user device 210.

In some implementations, at 635 the recalibration engine 250 can request additional real-time event data from the data ingestion module 270. For example, if the recalibration engine 250 is missing enough real-time data to calculate the updated predictive outcome or the user query requests a continuous live prediction, the recalibration engine 250 can request additional real-time event data from the data ingestion module 270. As another example, the recalibration engine 250 can receive an updated user query requesting additional information. At 640, the data ingestion module 270 can determine whether it can process the request from the recalibration engine locally. For example, the data ingestion module 270 can be processing the requested data already and can provide the recalibration engine 250 with the new real-time event at 645.

In some implementations, in response to determining the real-time event, the data ingestion module 270 can initiate a first API call to a first external database to obtain a first statistic. For example, at 650, if the data ingestion module 270 does not have the requested information, the data ingestion module 270 can initiate an API call to service A 280 to obtain a first statistic. The first statistic can include additional real-time event feeds, additional data, or new statistics. In some implementations, at 655 the data ingestion module 270 can initiate a second application programming interface call to a second external database to obtain a second statistic. In some implementations, the data ingestion module 270 can initiate an application programming interface call to service A 280 and service B 290, or other services not shown in FIG. 6. At 660, the first statistic can be provided to the data ingestion module 270. At 665, the second statistic can be provided to the data ingestion module 270.

In some implementations, the machine learning model 330 can be applied to the first statistic received from the first external database and the predictive outcome to generate the updated predictive outcome. For example, at 670, the first statistic can be provided to the recalibration engine 250 after being received by the data ingestion module 270. At 675, the machine learning model 330 can be applied to the first statistic received from the first external database and the predictive outcome to generate the updated predictive outcome. A similar process can be used to generate the updated predictive outcoming using the second statistic.

The network 240 can be parallelized to optimize latency during the API calls. For example, in some implementations the first API call can be initiated prior to the second API call. In such situations, if the second statistic can be obtained from the second external database prior the obtaining the first statistic from the first external database, the machine learning model can be applied to the second statistic while waiting to obtain the first statistic from the first external database. This can improve the network's latency and provide timely results to the user device 210.

At 685, the updated predictive outcome can be provided to the user device 210. In some implementations, a user interface can be generated that provides an intermediate predictive outcome while waiting to obtain the first statistic from the first external database. For example, if the machine learning model has already processed the predictive outcome and the second statistic, the recalibration engine 250 can provide the intermediate predictive outcome to the user while waiting to obtain the first statistic from the first external database. This can be useful in situations where the user query asks for a real-time event that has not happened yet or is ongoing, but the recalibration engine 250 can still provide intermediate predictive feedback to the user. For example, if a player is injured during a sporting event, the recalibration engine 250 can provide an intermediate prediction on how the injury may impact the score without knowing the fully severity of the injury. If a statistic regarding the full extent of the injury is received, such as the player is out for the remainder of the game, the recalibration engine 250 can provide the updated predictive outcome on how the injury may impact the score. In some implementations, the user interface can be generated that provides an intermediate predictive outcome while waiting to obtain the second statistic from the second external database.

In some implementations, the network 240 can continuously determine additional real-time events by monitoring the real-time event feed and continuously apply the machine learning model to the additional real-time events and the predictive outcome to generate the updated predictive outcome. For example, at 680, the recalibration engine 250 can continuously perform steps 625-675 and continuously update the predictive outcome. This can be useful in live sports betting, where the betting recommendation can be continuously updated as the game progresses and more real-time events are received.

In some implementations, the continuously determining the additional real-time events and the continuously applying the machine learning model 330 occur concurrently using parallel processing. For example, the recalibration engine 250 can be applying the machine learning model to additional real-time events and the predictive outcome while the data ingestion module 270 can be determining additional real-time events by monitoring the real-time event feed.

Although a few variations have been described in detail above, other modifications or additions are possible. For example, the recalibration engine 250 can include a simulation engine 310 to calculate odds based on simulated outcomes. For example, the simulation engine 310 can include a pricing engine that adjust odds and predictions based on various simulation models. Additionally, the simulation engine 310 can recommend odds and automatically place bets in the betting market without user intervention. In some implementations, the user can override the pricing engine and define specific odds or prices for a given bet. As another example, the simulation engine 310 can use Kelly Criterion formulas to calculate the optimal bet size as a proportion of the user's bankroll or financial input. As another example, the process flow depicted in the accompanying figures and described herein do not require the particular order shown, or sequential order, to achieve desirable results. Other embodiments may be within the scope of the following claims. The system allows users to choose between full Kelly and fractional Kelly strategies. For risk-averse users, the system can suggest a fractional bet size (e.g., half-Kelly) to reduce exposure, balancing between growth potential and risk of ruin.

The subject matter described herein provides many technical advantages. For example, some implementations of the current subject matter can provide an approach to determine a predictive outcome using historical information and an updated predictive outcome based on the predictive outcome and real-time information. By determining the outcomes based on historical and real-time information, some implementations of the current subject matter can provide recalibrated predictions based on real-time information. These predictions can be more accurate and responsive based on the latest, most relevant data. As another example, some implementations include application programming interface calls to an external database to obtain statistics indicative of how the real-time event affects the predictive outcome. This can provide more granular predictions that would not be possible using only historical data.

Additionally, some implementations of the subject matter can parallelize the machine learning model analysis. This can enable faster data processing and provide real-time recommendations with minimal delay. This can be useful in environments where speed is critical, such as betting opportunities, financial predictions, supply chain management, and other real-time scenarios. Further, some implementations can reduce the latency required to process the real-time events, enabling access to larger and computationally complex datasets.

The following functionalities may be included in the real-time event simulation system:

Scalability: The core of this system is designed to handle large volumes of real-time data from multiple sports events, adjusting its predictions and recommendations as conditions change. This is a critical aspect of scalability because, as the number of simultaneous sports events increases (e.g., during major tournaments or multiple games across different sports), the system can continue to ingest and process data without a significant drop in performance.

For example, during events like the NFL Playoffs or March Madness, the system can handle an influx of real-time data streams from multiple games, each with its own unique events (e.g., touchdowns, injuries, odds changes, officiating biases, key player biases). It dynamically recalibrates its predictions across all active games without lag.

Versatility between machine learning models: A neural network model might be prioritized during live events to recognize patterns in scoring momentum, while logistic regression model may be more effective for binary outcomes, like win/loss predictions, in pre-game scenarios.

Cloud-Based Processing: The system can leverage cloud infrastructure to scale processing power as needed. When more games are occurring, additional cloud instances are spun up to handle the increased data load, ensuring that real-time updates and recalibrations remain fast and accurate, no matter the number of active users or games being tracked.

User Scalability: The system can manage millions of users simultaneously, each receiving personalized betting recommendations. It tracks user interactions to adjust suggestions in real time, ensuring the platform remains responsive as user activity spikes during major sports events.

### Linear Programming in Sports Betting AI

Integrating with Monte Carlo Simulations: While Monte Carlo simulations generate a wide range of potential outcomes, linear programming (LP) can be used to refine these projections by identifying optimal scenarios and assigning probabilities to them.

Scenario Optimization: LP can evaluate all possible outcomes from a Monte Carlo simulation and select the subset of scenarios that maximize the expected return based on specific constraints like user risk tolerance, desired odds, or time remaining in a game.

Balancing Long-Term vs. Short-Term Projections: The LP model can optimize the balance between short-term events (like immediate game outcomes) and long-term season projections. For example, if betting on future events (e.g., championship winners), LP can allocate resources based on projections of how various teams are expected to perform throughout a season.

### Betting Optimization for Arbitrage Opportunities

Identifying Arbitrage Opportunities: LP can be used to identify arbitrage opportunities by comparing odds across multiple sportsbooks in real-time. The system can determine how to place bets on all possible outcomes to guarantee a profit regardless of the event's outcome.

Optimal Allocation for Arbitrage: LP helps calculate the precise amounts to wager on each outcome at different sportsbooks to ensure that the combined returns exceed the total amount wagered, thus locking in a guaranteed profit.

Real-Time Arbitrage Adjustments: The LP model can also adjust these allocations dynamically as odds shift during live events, ensuring that the arbitrage position remains valid even when the market changes.

### Top-Down Betting Optimization

Top-Down Approach: This method focuses on leveraging market inefficiencies. LP can analyze odds movements across sportsbooks and identify bets where a particular book's line is out of sync with the broader market.

Optimizing Bet Allocation: Using LP, the system can determine the optimal amount to place on these “mispriced” bets to exploit the market inefficiencies, ensuring that the bettor takes full advantage of the opportunity while managing their exposure to risk.

Market Liquidity Considerations: LP can factor in liquidity at each sportsbook or sportsbook marketplaces, adjusting the size of the bet based on how much the market can absorb without significantly shifting the line. This is crucial for high-stakes bettors who may need to distribute their wagers across multiple books.

### Combining Constraints for Comprehensive Optimization:

Multi-Objective Optimization: Linear programming allows the system to consider multiple objectives at once, such as maximizing expected profit while minimizing variance (risk). This is particularly valuable when combining strategies like arbitrage with more traditional bet projections.

Dynamic Constraints: Constraints in the model can be dynamically adjusted based on user preferences or changing game conditions. For instance, if a user sets a lower risk tolerance mid-game, the LP model can instantly re-optimize bet allocations to reflect this change.

Integrating User Behavior: The LP framework can also include constraints based on observed user behavior, such as preferences for certain bet types or markets (e.g., prop bets, parlays). This ensures that the AI's recommendations align closely with the user's past betting behavior.

### Training Data:

Historical Data: Includes game results, player stats, betting odds history, and external factors like weather conditions. This helps the AI learn general trends and relationships between different variables (e.g., how weather affects player performance).

### Examples:

Game Results: For instance, if the AI is analyzing NFL games, it would use data from past seasons to learn how different teams and players perform under various conditions. It might find that a specific quarterback struggles in cold weather based on previous games in sub-zero temperatures, influencing its prediction of outcomes for future cold-weather games.

Player Stats: If a player like Lebron James averages a specific number of points and rebounds per game in playoff matches, the AI would use this data to adjust the expected performance of the Lakers in a playoff scenario.

Betting Odds History: By analyzing how odds changed in previous events leading up to key games, such as the Super Bowl, the AI can recognize patterns in how sportsbooks adjust odds and align its recommendations with those trends.

Weather Conditions: If the AI notices that MLB games at Wrigley Field tend to have lower scores when there's a strong wind blowing in from the outfield, it uses this insight to adjust the predicted totals (over/under) for games when similar wind conditions are forecasted.

B. Real-Time Data: Includes live game updates (e.g., injuries, score changes), real-time odds from sportsbooks, social streams, and user betting behavior. This helps the AI adapt to new events as they happen, allowing it to adjust its predictions dynamically.

Live Game Updates: During an NBA game, if a star player like Stephen Curry is injured and taken out of the game, the AI would instantly adjust its probability calculations for the Golden State Warriors' chances of winning that game.

Real-Time Odds: Suppose a sportsbook shifts the moneyline odds for a Premier League soccer match from −150 to −170 due to heavy betting on one side. The AI could detect this shift and recommend a different strategy for users to take advantage of the new value created by the odds change.

User Betting Behavior: If a user frequently places bets on underdogs and sees consistent losses in those scenarios, the AI could learn from this behavior and suggest bets that are more in line with the user's risk tolerance, like smaller spreads or safer favorites.

Supervised Learning: Initially, the AI model is trained using supervised learning with historical game and betting data to predict outcomes and understand how different factors correlate with game results. It learns relationships like how changes in player performance impact game outcomes.

Reinforcement Learning Example: The AI uses RL to improve predictions by learning from real-time game outcomes and user feedback. For instance, if the AI suggests betting on the Lakers to win when they're trailing by 10 points in the third quarter, and the users following this recommendation win, the AI treats this as positive feedback. It adjusts its model to increase confidence in similar recommendations for future games when a strong team is trailing. Conversely, if the Lakers lose, it treats this as negative feedback and reduces the likelihood of making similar bets under those conditions.

This process allows the AI to continuously refine its decision-making, making it more accurate in dynamic, real-time scenarios like live sports betting, where conditions can change rapidly (e.g., player injuries, shifts in momentum).

Feature Engineering: The AI uses feature engineering to create new predictive features from the data, such as momentum scores (recent win/loss streaks), player fatigue levels, or shifts in betting line movements.

Online Learning: The system continuously refines its predictions as new data comes in, allowing it to stay current with the latest trends in sports and betting behavior.

### Push Notifications and Text Messages for Conveying Continuing Data

### 1. AI-Adjusted Updates Based on Projection Changes:

### Real-Time Adjustments Example:

During an NBA game, if a star player like Lebron James is injured in the third quarter, the AI immediately recalculates the Lakers' win probability based on the impact of his absence. A push notification is sent to users, stating, “LeBron out due to injury. Adjusted win probability for the Lakers now 42%-consider updating your bet.”

This allows users to react quickly before the sportsbooks adjust their odds, giving them a time-sensitive edge.

### Dynamic Notification Triggering Example:

In a Premier League soccer match, if a late goal changes the expected total goals from under 2.5 to over 2.5, the AI triggers a push alert, notifying users: “Projected total goals for Man Utd vs. Liverpool has shifted—bet on over 2.5 goals for better returns.”

This alert gives users the opportunity to place bets based on the updated projection before other bettors drive the odds down.

### 2. Linear Programming Optimized Event Updates:

### Optimized Betting Allocation Alerts Example:

Suppose a user is betting on an NFL game, and the point spread suddenly shifts due to a key touchdown. The AI uses linear programming to calculate a new optimal bet allocation, adjusting how much of the user's bankroll should be placed on different outcomes. The user receives a notification: “Spread shifted to −4.5. Adjusted bet recommendation: place $50 on the new line to maximize potential returns.”

This ensures users are making data-driven adjustments with clear guidance on the precise amounts to wager.

### Arbitrage Opportunities Example:

If sportsbooks show a discrepancy in odds for a boxing match, where one book offers +150 for Fighter A, while another offers +130 for Fighter B, the AI detects this and calculates the precise amounts to bet on each side to secure a risk-free profit. Users receive a message like: “Arbitrage alert: Bet $100 on Fighter A at Book A, $90 on Fighter B at Book B for a guaranteed 3% profit.”

This type of alert allows users to capitalize on short-lived market inefficiencies with clear instructions on how to execute the bets.

### 3. Personalized AI Recommendations and Alerts:

### User-Specific Adjustments Example:

For a user who prefers betting on MLB underdogs, the AI recognizes that a pitching change in the fifth inning makes an underdog more likely to win. It sends a push notification to that user: “Pitching change for the Mets-adjusted underdog win probability now 37%. Recommended bet: $25 on Mets.”

This provides a tailored betting suggestion that aligns with the user's preferences and the AI's updated analysis.

### Game State-Based Notifications Example:

During a college football game, if a team scores two quick touchdowns to shift the momentum, the AI recalibrates the outcome probabilities and sends a text message: “Momentum shift: Texas A&M now favored. Adjusted bet recommendation: consider halftime line at −3.5.” This allows users to adjust their bets based on the real-time game momentum and the AI's updated projections.

Automated Bet Placement Engine: A bet placement engine configured to allow users to automatically place a bet at the sportsbook with the most favorable odds through a single interface, without the need to manually switch between sportsbook platforms. The system is configured to generate and load the betslip directly into the chosen sportsbook based on the identified best odds.

Synthetic Hold Calculation Module: A module configured to continuously monitor odds across multiple sportsbooks and calculate the synthetic hold percentage in real time by comparing the implied probabilities for each side of a betting event.

Arbitrage Opportunity Alert System: A system configured to automatically alert users when the synthetic hold percentage falls below a defined threshold or becomes negative, indicating the availability of a profitable arbitrage opportunity.

Social Bet Sharing and Group Betting Experience: A system for enabling social bet sharing and group betting experiences, allowing users to share betslips and participate in collective wagers, comprising:

Betslip Sharing Module: A module configured to allow users to share their personalized betslips with other users or on social media platforms, enabling others to replicate the exact betslip into their own sportsbook account.

Group Betting Interface: An interface configured to enable users to collaborate on group bets, wherein multiple participants can contribute to the same betslip, with the system tracking individual contributions and distributing winnings based on predefined parameters.

Automated Prop Bet Search and Alert System Using Natural Language Processing: A system for enabling users to find and set alerts for prop bets using natural language processing (NLP), comprising:

Natural Language Processing Module: A module configured to accept user queries in natural language, wherein users can input requests such as “Find the best player prop bets for tonight's NBA games,” and the system parses the query to identify and display relevant prop bets across multiple sportsbooks.

Prop Bet Alert System: A system configured to allow users to set alerts for specific prop bets or betting conditions, with the system sending real-time notifications when these bets become available or when odds meet the user's predefined criteria.

Method for User-Specific Real-Time Sports Prediction: A method for generating dynamic, user-specific sports betting predictions, comprising: applying a machine learning model to historical outcomes and a user query parsed into keyword vectors, generating an initial prediction. Additionally, continuously updating the predictive outcome by incorporating prioritized real-time event data, weighted based on high-impact user preferences like team, sport, player, and event type (e.g., regular season or playoffs). Further, recalibrating predictions based on user-defined constraints, including risk tolerance, betting type, and odds preferences. This method may ben expanded to cover dynamic user specificity and prioritization of high-impact real-time data, supporting broader claims to adaptability in real-time sports betting.

Database-Driven Historical Data Access: A method of accessing historical data, comprising parsing the user query into keyword vectors to select relevant historical outcomes from a coupled database, where outcomes are categorized by event type, player, and sport-specific factors. This method details database coupling and categorization of outcomes, which addresses adaptability across different sports or data types.

Threshold-Based Prediction Adjustment: A method for dynamic prediction recalibration based on error threshold detection, comprising calculating prediction error in real-time and triggering predictive updates when a user-defined error threshold is met, allowing customized sensitivity to real-time changes. This includes user-defined sensitivity and threshold triggers to increase flexibility and user control, covering a broader set of applications.

Real-Time Event API Integration: Initiating, upon detection of a prioritized real-time event, an API call to obtain data from an external projection engine, dynamically updating the predictive outcome based on received data relevant to user-defined criteria. This enhances the scope by detailing API integration for external projections, making it broader in adaptability.

Sequential API Calls and Data Weighting: A method for sequential data integration, comprising: Initiating calls to external databases prioritized by data relevance and integrating received statistics, recalibrating predictions based on weighted contributions of each data source. This incorporates data prioritization and weighting, enabling the system to use multi-source data effectively for improved predictions.

Intermediate Predictive Outcome Display: Generating an interactive user interface to display intermediate predictive outcomes, allowing real-time user adjustments based on currently available data while awaiting additional inputs. This Expands to include user interaction, enabling real-time adjustments to increase user engagement and utility.

Continuous Monitoring and Parallel Processing: Continuously monitoring and parallel processing multiple real-time event feeds, dynamically updating predictions based on high-impact events using concurrent application of the model. Enhanced to detail concurrent processing, improving responsiveness for multi-stream real-time environments.

Monte Carlo and Linear Programming Integration: Generating probabilistic predictions using Monte Carlo simulations refined through multi-objective linear programming to optimize predicted outcomes based on constraints like user-defined bankroll, preferred odds, and risk tolerance. Added multi-objective linear programming and user constraints, allowing adaptive prediction adjustments.

Multi-Sourced Real-Time Data Aggregation: Aggregating multi-sourced real-time event data, dynamically structuring it for high-relevance events through a priority queue, and updating predictions based on the impact of critical events. Provides adaptability by detailing the use of multi-sourced data, covering scenarios across diverse data providers.

User-Defined Bet Optimization with Kelly Criterion: A method to optimize bet allocation using the Kelly Criterion, comprising: recommending bet sizing based on risk tolerance, bankroll, and current odds, with optional fractional or full Kelly application. This introduces the Kelly Criterion, giving the system financial optimization capabilities tied to user-defined risk and reward factors.

Real-Time Arbitrage Engine: An arbitrage engine that detects discrepancies across multiple sportsbooks in real time, dynamically calculating optimal bet allocations to secure risk-free profits and notifying the user with precise wagering instructions. This provides arbitrage functionality, enhancing the system's utility for professional betting use.

Event-Type Specific Projections: Customized projections for event types, categorizing real-time data by specific sports or event types like playoffs, regular season, or championship, with tailored prediction adjustments for each. Explanation: More specific handling of “event type,” covering different sports scenarios.

User Behavior Learning and Prediction Feedback: Tracking user betting behavior over time to adaptively adjust predictions based on historical success rates and response patterns, improving prediction reliability. Adds adaptability, allowing the model to learn from individual betting history.

Bet Placement Interface with Platform Integration: Interface for direct bet placement across multiple sportsbooks, dynamically loading best odds into a bet slip and integrating across platforms to streamline user betting actions. Covers platform integration, making the system functional across various betting sites.

Synthetic Hold Calculation for Arbitrage Detection: A method to calculate synthetic hold by comparing implied odds across sportsbooks, automatically identifying opportunities for profitable arbitrage when the hold percentage turns negative. Explanation: Introduces synthetic hold calculations, useful for advanced bettors targeting arbitrage.

Social Bet Sharing and Group Betting Interface: Interface enabling users to share personalized bet slips or participate in collective bets, tracking individual contributions and winnings across participants. Expands functionality to include social and group betting, appealing to a wider user base.

Automated Prop Bet Detection Using NLP: Prop bet detection system utilizing NLP, allowing users to set alerts for specific bets in natural language, such as player-specific or game-specific outcomes. Adds advanced NLP, improving user interaction with prop bets.

Real-Time Prediction Error Adjustment with User Feedback: Adjusting prediction error tolerance interactively based on user feedback, allowing users to modify sensitivity to real-time updates dynamically. User-driven error tolerance adjustment for real-time prediction refinement.

System-Driven User Behavior Alerts for Responsible Betting: Behavior detection module that tracks user patterns for signs of risky betting, offering alerts and resources when indicators align with impulsive or high-risk patterns. Introduces responsible betting elements, supporting a broader, user-protective system.

Multi-Layered Priority Queue for Real-Time Event Processing: Multi-layered priority queue that dynamically prioritizes real-time data feeds, giving precedence to high-impact events like injuries or critical scores, updating predictions in order of priority. Detailed priority queue process enhances responsiveness to critical game events, improving prediction relevance in high-stakes scenarios.

Event Type: Refers to specific categories of sporting events, including but not limited to regular season games, playoff games, championship events, and individual player performance events.

Prediction Error: The deviation between the predicted outcome generated by the system and the actual observed outcome. This error can be calculated using various statistical measures (e.g., root mean square error) and is dynamically used to recalibrate predictions based on user-defined sensitivity.

Prediction Error Threshold: the prediction error threshold can indicate the minimum level of change required to justify providing the updated predictive outcome. In some implementations, the prediction error threshold can indicate a maximum allowable change before providing the updated predictive outcome. The prediction error threshold may be satisfied is the updated outcome has a 2% chance or greater of affecting the final outcome. The prediction error threshold may be determined by user criteria. For example, a user may decide a betting threshold needs to change by $5. In some embodiments, deviation measured by mean absolute error or root mean square error determines the prediction error threshold.

Real-Time Event: Any event or occurrence impacting the predictive model in real-time, prioritized by significance. Examples include injuries, score changes, weather conditions, and betting line movements.

User-Specific Criteria: Settings and preferences defined by the user, including sport, team, player preferences, event type, bet type, odds threshold, and risk tolerance. These criteria directly influence the model's predictive outcomes.

### Key System Components

### Data Ingestion Module:

The data ingestion module retrieves historical and real-time data from multiple sources, including internal databases and third-party APIs. Data types include but are not limited to team and player statistics, environmental conditions, betting odds, and social media sentiment.

Process: Historical data is preprocessed and stored, while real-time data is processed as events occur, structured for immediate analysis by the predictive model. The module ingests real-time data at defined intervals (e.g., every minute or upon significant event detection) to ensure predictive relevance.

### Priority Queue:

A priority queue classifies and ranks real-time events by relevance and impact based on predefined weights. High-impact events (e.g., player injuries, score changes) are processed with higher priority, ensuring they influence the model's predictions immediately.

Function: This system mitigates prediction noise by reducing the influence of low-impact events. Events are dynamically re-prioritized based on the current game state, user preferences, and prediction error feedback.

### Feedback Loop:

The feedback loop monitors prediction accuracy, recalibrating predictive weightings based on accuracy results. When prediction error exceeds a user-defined threshold, the loop adjusts model parameters, effectively learning from previous inaccuracies.

Example: If real-time data consistently deviates from predicted outcomes, the system might increase the weight of certain data sources (e.g., recent injury reports), enhancing future predictions.

### API Integration and Dynamic Usage

### API Integration Module:

The system includes an integration module for external API connections, enabling real-time data input from third-party projection engines. This module allows the predictive model to incorporate specialized data sources for enhanced accuracy.

Operation: API calls are triggered based on event significance and system requirements. For high-priority events, parallel processing is used to reduce latency, while sequential processing handles lower-priority updates.

### Examples of API Sources:

Sports Data APIs: Provides up-to-date and live, player statistics, team data, automated projections, and injury reports.

Betting Market APIs: Supplies real-time betting odds, market liquidity data, and line movement information.

### 4. Machine Learning Model Types and Adaptive Behavior

### Model Types:

The system employs multiple machine learning model types to optimize predictive accuracy, including neural networks for pattern recognition, logistic regression for win/loss probabilities, and ensemble methods for combining predictions.

Adaptive Model Behavior: Models adapt in real time by incorporating new data layers based on prediction error and event priority. If a player injury significantly impacts a prediction, the model may adjust weightings for that player's performance impact on team outcomes.

### Example of Adaptive Behavior:

If a user shows a consistent preference for underdog teams, the system might adjust model parameters to increase sensitivity to factors favoring the underdog, such as weather or key player conditions.

### 5. User Customization and Constraints

### User Customization Interface:

The user interface allows for real-time customization of predictive sensitivity, bet types, odds preferences, and risk tolerance. Adjustments can be made through sliders or toggle buttons for easy interaction.

Example Workflow: A user adjusts the risk tolerance slider to a low setting, causing the system to apply the Kelly Criterion fractionally to determine smaller, safer bet sizes. As a result, predictions recalibrate to prioritize more conservative outcomes, aligning with the user's risk preference.

### User-Specific Constraints:

Users can set constraints for specific sports, players, prop types (e.g. touchdowns, receiving yards, etc.) and bet sizes, influencing both the prediction model and betting recommendations. These constraints help ensure that predictions align with individual user strategies.

### 6. Data Privacy and Security

### Data Anonymization:

User data is anonymized upon collection, removing identifiable details before any storage or processing. Anonymization protocols apply throughout the system, ensuring that all data used for machine learning and predictions is de-identified.

### Encryption and API Security:

Data transmission, particularly with external APIs, is secured through encryption standards (e.g., AES-256) to maintain confidentiality and integrity of user data. Additionally, the system applies access control measures to limit API access based on authentication tokens and user permissions.

### User Data Control:

Users have control over data-sharing preferences through settings that allow them to toggle the use of certain data sources or opt out of specific third-party integrations, enhancing user trust and compliance with privacy standards.

### 7. Prioritization Mechanism for Real-Time Event Processing

### Prioritization Criteria and Weights:

The system uses a priority scoring algorithm to rank real-time events by relevance to predictive accuracy. Events such as player injuries, significant weather changes, and score shifts are assigned the highest weights, while minor events (e.g., commentary updates) receive lower weights. For example, high-priority events (e.g., injuries, score changes) may be processed immediately, with lower-priority updates handled sequentially to ensure predictive relevance without latency. This weighting reinforces the system's adaptability to fast-changing events, which is critical in sports betting applications.

### Latency Management:

High-priority events are processed immediately in parallel to maintain system latency under defined limits (e.g., sub-second processing for critical updates). Lower-priority events are queued and processed sequentially, ensuring that high-impact events remain the focus without excessive delay.

### Example of Prioritization:

During a game, a player's injury receives immediate attention and a high weight, impacting all predictions involving that player's team. Meanwhile, a minor scoring change (e.g., play resulting in an error) might be queued with a lower priority, updated in subsequent predictions without disturbing the immediate response.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method for generating dynamic, user-specific sports betting simulations, the method comprising:
applying a machine learning model to a first historical outcome and a second historical outcome to generate a predictive outcome responsive to a user query, the first historical outcome and the second historical outcome selected based on a first keyword vector and a second keyword vector obtained by parsing the user query;
applying the machine learning model to a real-time event and the predictive outcome to generate an updated predictive outcome, the real-time event obtained by parsing the real-time event from a real-time event feed, the real-time event parsed from the real-time event feed based on the first keyword vector and the second keyword vector; and
determining a prediction error indicative of a difference between the predictive outcome and the updated predictive outcome.

2. The method of claim 1, wherein the first historical outcome and the second historical outcome are obtained by searching a historical database using the first keyword vector and the second keyword vector, the historical database being communicatively coupled to the machine learning model, and wherein the first historical outcome and the second historical outcome are categorized by at least one of an event type, a player, and a sport-specific factor.

3. The method of claim 1, further comprising:
providing the updated predictive outcome in response to the prediction error satisfying a prediction error threshold, wherein the prediction error is calculated in real-time and wherein satisfying the prediction error threshold prompts a response to the user query using the updated predictive outcome, and wherein the prediction error threshold is set based on user criteria.

4. The method of claim 1, further comprising:
initiating, in response to determining the real-time event, a first application programming interface call to a first external database to obtain a first statistic, the first statistic indicative of how the real-time event affects the predictive outcome,
wherein the applying the machine learning model to the real-time event and the predictive outcome to generate the updated predictive outcome further comprises applying, in response to the first application programming interface call, the machine learning model to the first statistic received from the first external database and the predictive outcome to generate the updated predictive outcome.

5. The method of claim 4, further comprising:
initiating, in response to determining the real-time event, a second application programming interface call to a second external database to obtain a second statistic, the second statistic indicative of how the real-time event affects the predictive outcome,
wherein the applying the machine learning model to the real-time event and the predictive outcome to generate the updated predictive outcome further comprises applying, in response to the second application programming interface call, the machine learning model to the second statistic received from the second external database and the predictive outcome to generate the updated predictive outcome, and
wherein the second statistic is weighed by the machine learning model more than the first statistic for generating the updated predictive outcome.

6. The method of claim 5, wherein the first application programming interface call is initiated prior to the second application programming interface call, wherein the second statistic is obtained from the second external database prior the obtaining the first statistic from the first external database, and wherein the machine learning model is applied the second statistic while waiting to obtain the first statistic from the first external database.

7. The method of claim 6, further comprising:
generating a user interface that provides an intermediate predictive outcome while waiting to obtain the first statistic from the first external database, the intermediate predictive outcome generated in response to generating the updated predictive outcome based on applying the machine learning model to the second statistic and the predictive outcome.

8. The method of claim 1, further comprising:
continuously determining additional real-time events by monitoring the real-time event feed using the first keyword vector and the second keyword vector obtained from the user query; and
continuously applying, in response to determining the additional real-time events, the machine learning model to the additional real-time events and the predictive outcome to generate the updated predictive outcome.

9. The method of claim 8, wherein the continuously determining the additional real-time events and the continuously applying the machine learning model occur concurrently using parallel processing.

10. The method of claim 1, wherein the machine learning model is configured to generate Monte Carlo simulations that are refined using linear programming to optimize prediction outcomes, the refining using linear programming including assigning probabilities to the Monte Carlo simulations, wherein the Monte Carlo simulations are based on at least one of user-defined bankroll, a preferred odd, and a risk tolerance.

11. A system for generating dynamic, user-specific sports betting simulations, the system comprising:
at least one data processor; and
memory storing instructions configured to cause the at least one data processor to perform operations comprising:
applying a machine learning model to a first historical outcome and a second historical outcome to generate a predictive outcome responsive to a user query, the first historical outcome and the second historical outcome selected based on a first keyword vector and a second keyword vector obtained by parsing the user query;
applying the machine learning model to a real-time event and the predictive outcome to generate an updated predictive outcome, the real-time event obtained by parsing the real-time event from a real-time event feed, the real-time event parsed from the real-time event feed based on the first keyword vector and the second keyword vector; and
determining a prediction error indicative of a difference between the predictive outcome and the updated predictive outcome.

12. The system of claim 11, wherein the first historical outcome and the second historical outcome are obtained by searching a historical database using the first keyword vector and the second keyword vector, the historical database being communicatively coupled to the machine learning model, and wherein the first historical outcome and the second historical outcome are categorized by at least one of an event type, a player, and a sport-specific factor.

13. The system of claim 11, further comprising:
providing the updated predictive outcome in response to the prediction error satisfying a prediction error threshold, wherein the prediction error is calculated in real-time and wherein satisfying the prediction error threshold prompts a response to the user query using the updated predictive outcome, and wherein the prediction error threshold is set based on user criteria.

14. The system of claim 11, further comprising:
initiating, in response to determining the real-time event, a first application programming interface call to a first external database to obtain a first statistic, the first statistic indicative of how the real-time event affects the predictive outcome,
wherein the applying the machine learning model to the real-time event and the predictive outcome to generate the updated predictive outcome further comprises applying, in response to the first application programming interface call, the machine learning model to the first statistic received from the first external database and the predictive outcome to generate the updated predictive outcome.

15. The system of claim 14, further comprising:
initiating, in response to determining the real-time event, a second application programming interface call to a second external database to obtain a second statistic, the second statistic indicative of how the real-time event affects the predictive outcome,
wherein the applying the machine learning model to the real-time event and the predictive outcome to generate the updated predictive outcome further comprises applying, in response to the second application programming interface call, the machine learning model to the second statistic received from the second external database and the predictive outcome to generate the updated predictive outcome, and
wherein the second statistic is weighed by the machine learning model more than the first statistic for generating the updated predictive outcome.

16. The system of claim 15, wherein the first application programming interface call is initiated prior to the second application programming interface call, wherein the second statistic is obtained from the second external database prior the obtaining the first statistic from the first external database, and wherein the machine learning model is applied the second statistic while waiting to obtain the first statistic from the first external database.

17. The system of claim 16, further comprising:
generating a user interface that provides an intermediate predictive outcome while waiting to obtain the first statistic from the first external database, the intermediate predictive outcome generated in response to generating the updated predictive outcome based on applying the machine learning model to the second statistic and the predictive outcome.

18. The system of claim 11, further comprising:
continuously determining additional real-time events by monitoring the real-time event feed using the first keyword vector and the second keyword vector obtained from the user query; and
continuously applying, in response to determining the additional real-time events, the machine learning model to the additional real-time events and the predictive outcome to generate the updated predictive outcome.

19. The system of claim 18, wherein the continuously determining the additional real-time events and the continuously applying the machine learning model occur concurrently using parallel processing.

20. The system of claim 11, wherein the machine learning model is configured to generate Monte Carlo simulations that are refined using linear programming to optimize prediction outcomes, the refining using linear programming including assigning probabilities to the Monte Carlo simulations, wherein the Monte Carlo simulations are based on at least one of user-defined bankroll, a preferred odd, and a risk tolerance.
